(19) United States
(12) Patent Application Publication
(10) Pub. No.: US 2026/0353204 A1
(43) Pub. Date: Nov. 5, 2026

(54) DOWNLINK PRE-SYNCHRONIZATION IN LTM CELL SWITCH PROCEDURE

(71) Applicant: Telefonaktiebolaget LM Ericsson (publ), Stockholm (SE)

(72) Inventors: Venkatarao GONUGUNTLA, Sundbyberg (SE); Claes TIDESTAV, BÅLSTA (SE); Icaro Leonardo DA SILVA, SOLNA (SE); Antonino ORSINO, KIRKKONUMMI (FI); Maomao CHEN LARSSON, LUND (SE)

(73) Assignee: Telefonaktiebolaget LM Ericsson (publ), Stockholm (SE)

(21) Appl. No.: 19/472,757

(22) PCT Filed: Apr. 4, 2024
(86) PCT No.: PCT/EP2024/059185

§ 371 Date: Oct. 6, 2025

Related U.S. Application Data
(60) Provisional application No. 63/456,851, filed on Apr. 4, 2023.

(51) Int. Cl. H04W 36/00; H04W 56/00

(52) U.S. Cl. CPC H04W 36/0072; H04W 36/00835; H04W 56/001

(57) ABSTRACT

A method by a UE for performing an L1/L2 based inter-cell mobility (LTM) cell switch includes receiving an LTM configuration including an LTM candidate cell configuration for the LTM, receiving an indication of an LTM candidate cell, and performing DL pre-synchronization with the LTM candidate cell. The UE receives an LTM cell switch command from a serving cell indicating that the UE needs to access and switch to the LTM candidate cell, and transmits, in response to the LTM cell switch command, an uplink, UL, signal to the LTM candidate cell. Related network node methods are also disclosed.

### TECHNICAL FIELD

The present disclosure relates to wireless communication networks, and in particular to establishment of timing alignment in wireless communication networks.

### BACKGROUND

In Rel-18, 3GPP has agreed on a Work Item on Further New Radio (NR) mobility enhancements, in particular, in a technical area entitled L1/L2 based inter-cell mobility (LTM).

According to the Work Item description for LTM, when the UE moves from the coverage area of one cell to another cell, a serving cell change needs to be performed. Currently, a serving cell change is triggered by L3 measurements, and is done by radio resource control (RRC) signalling that triggers a Reconfiguration with Synchronization for change of PCell and PSCell, as well as release/add for SCells when applicable. All cases involve complete L2 (and L1) resets, leading to longer latency, larger overhead and longer interruption time than beam switch mobility. The goal of L1/L2 mobility enhancements is to enable a serving cell change via L1/L2 signalling as a way to reduce latency, signalling overhead and interruption time.

As part of L1-L2 inter-cell mobility measurement framework, it was agreed to support at least L1-RSRP as the reporting quantity. That means UE is required to report L1-RSRP of the candidate cells to the network (NW) so that NW can use them for LTM handover (HO) decisions.

In Rel-17, a solution has been standardized as part of inter-cell beam management in which L1-RSRP is measured and reported on a CSI resource that are not associated to a physical cell identity (PCI) of the serving cells.

Layer 3 handover requirements specified in [2] are reproduced in Table 1 below.

TABLE 1
Excerpt from 3GPP TS 38.133 V18.0.0

6.1.1.2.1 Handover delay
When the UE receives a RRC message implying handover the UE shall be ready to start the transmission of
the new uplink PRACH channel within D_{handover} msec from the end of the last TTI containing the RRC
command.
Where:
D_{handover} equals the applicable RRC procedure delay defined in clause 12 in TS 38.331 [2] plus the
interruption time stated in clause 6.1.1.2.2.
6.1.1.2.2 Interruption time
The interruption time is the time between end of the last TTI containing the RRC command on the old
PDSCH and the time the UE starts transmission of the new PRACH, excluding the RRC procedure delay.
When intra-frequency or inter-frequency handover is commanded, the interruption time shall be less than
Tᵢₙₜₑᵣᵣᵤₚₜ
Tᵢₙₜₑᵣᵣᵤₚₜ = T_{search} + T_{IU} + T_{processing} + T_{Δ} + T_{margin} ms
Where:
T_{search} is the time required to search the target cell when the target cell is not already known when the
handover command is received by the UE. If the target cell is known, then T_{search} = 0 ms. If the target
cell is an unknown intra-frequency cell and the target cell Es/Iot ≥ −2 dB, then T_{search} = Tᵣₛ ms. If the
target cell is an unknown inter-frequency cell and the target cell Es/Iot ≥ −2 dB, then T_{search} = 3* Tᵣₛ ms.
Regardless of whether DRX is in use by the UE, T_{search} shall still be based on non-DRX target cell
search times.
T_{Δ} is time for fine time tracking and acquiring full timing information of the target cell. T_{Δ} = Tᵣₛ for
both known and unknown target cell.
T_{processing} is time for UE processing. T_{processing} can be up to 20 ms.
T_{margin} is time for SSB post-processing. T_{margin} can be up to 2 ms.
T_{IU} is the interruption uncertainty in acquiring the first available PRACH occasion in the new cell. T_{IU}
can be up to the summation of SSB to PRACH occasion association period and 10 ms. SSB to
PRACH occasion associated period is defined in the table 8.1-1 of TS 38.213 [3].
Tᵣₛ is the SMTC periodicity of the target NR cell if the UE has been provided with an SMTC
configuration for the target cell in the handover command, otherwise Trs is the SMTC configured in
the measObjectNR having the same SSB frequency and subcarrier spacing. If the measObjectNRs
having the same SSB frequency and subcarrier spacing configured by MN and SN have different
SMTC, Trs is the periodicity of one of the SMTC which is up to UE implementation. If the UE is not
provided SMTC configuration or measurement object on this frequency, the requirement in this clause
is applied with Tᵣₛ = 5 ms assuming the SSB transmission periodicity is 5 ms. There is no requirement if
the SSB transmission periodicity is not 5 ms. If the UE has been provided with higher layer in TS
38.331 [2] signaling of smtc2 prior to the handover command, Tᵣₛ follows smtc1 or smtc2 according to
the physical cell ID of the target cell.
In the interruption requirement a cell is known if it has been meeting the relevant cell identification
requirement during the last 5 seconds otherwise it is unknown. Relevant cell identification requirements are
described in Clause 9.2.5 for intra-frequency handover and Clause 9.3.4 for inter-frequency handover.

According to the requirements shown in Table 1, L3 HO delay (D_{handover}) equals the RRC processing delay of the HO command and the interruption time. The interruption delay includes software and hardware processing, cell search, acquisition of fine timing (sometimes called downlink, or DL, synchronization), and delay uncertainty of obtaining PRACH preamble.

### SUMMARY

Some embodiments provide systems/methods for a UE to reduce the delay in an LTM cell switch procedure with an LTM candidate cell by performing DL synchronization (with one or more LTM candidate cells) based on one or more conditions/rules, before the reception of an LTM cell switch command.

Some embodiments provide a method by a UE for performing an L1/L2 based inter-cell mobility (LTM) cell switch. The method includes receiving an LTM configuration including an LTM candidate cell configuration for the LTM, receiving an indication of an LTM candidate cell, performing DL pre-synchronization with the LTM candidate cell, receiving an LTM cell switch command from a serving cell indicating that the UE needs to access and switch to the LTM candidate cell, and transmitting, in response to the LTM cell switch command, an uplink, UL, signal to the LTM candidate cell.

The indication may be received in a radio resource control message, in a MAC CE, in Layer 1 or Layer 2 signalling, or in a PDCCH order.

The LTM configuration may include LTM candidate cell configurations for a plurality of LTM candidate cells, wherein the indication indicates which of the plurality of LTM candidate cells the UE should perform DL synchronization with.

Transmitting the UL signal may include transmitting the UL signal in a configured UL channel resource(s) in time and frequency.

The UE may be configured with a plurality of LTM candidate cell configurations for a plurality of LTM candidate cells, and the method may further include selecting a subset of the LTM candidate cells for performing DL synchronization before receiving the LTM cell switch command, wherein the selection of the subset of the LTM candidate cells is based on one or more rules.

The LTM cell switch command may correspond to a MAC Control Element (MAC CE), a Downlink Control Indication (DCI), a Layer 1, L1, signaling, a Layer 2, L2, signaling, and/or an L1/L2 signaling.

The UL signal may include a Physical Random Access Channel (PRACH) preamble transmitted to an UL channel of the LTM candidate cell, wherein the UL channel of the LTM candidate cell includes a PRACH.

The UL signal may include a scheduling request to an UL channel of the LTM candidate cell, wherein the UL channel of the LTM candidate cell includes Physical Uplink Control Channel, PUCCH.

The signal may include UL data to an UL channel of the LTM candidate cell, wherein the UL channel of the LTM candidate cell includes Physical Uplink Shared Channel, PUSCH.

Prior to receiving the LTM cell switch command indicating the LTM candidate cell from the serving cell, the UE may receive an LTM configuration from the serving cell with one or more LTM candidate cell configurations, to be applied upon reception of an LTM cell switch command.

Prior to receiving the LTM cell switch command indicating the LTM candidate cell, the UE may receive a configuration for timing alignment, TA, establishment/update with the LTM candidate cell.

The configuration for timing alignment may include a UL related parameter, a PRACH preamble configuration, a PRACH occasion, and/or a PRACH frequency resource.

Performing DL pre-synchronization with the at least one of the LTM candidate cells may include one or more of:
i) detecting and/or measuring at least one synchronization signal of the LTM candidate cell, wherein the synchronization signal includes a synchronization signal block, SSB, of the LTM candidate cell associated to an SSB index and/or identifier and transmitted in a spatial direction or beam, and/or a channel state indicator reference signal, CSI-RS, a tracking reference signa, TRS, a primary synchronization signal, PSS, and/or a secondary synchronization signal, SSS,
ii) performing fine time tracking and acquiring full timing information of the LTM candidate cell,
iii) obtaining the time boundaries of time units of a given LTM candidate cell such as time slot, orthogonal frequency division multiplexing, OFDM, symbol, subframe, radio frame, and
iv) synchronizing a clock with the boundaries of time units of a given LTM candidate cell such as time slot, OFDM symbol, subframe, radio frame.

Some embodiments provide a method by a network node for causing a UE to perform an LTM cell switch with an LTM candidate cell. The method includes transmitting an LTM configuration including an LTM candidate cell configuration to cause the UE to perform downlink, DL, pre-synchronization with an LTM candidate cell, transmitting an indication of an LTE candidate cell, and transmitting an LTM cell switch command to the UE indicating that the UE needs to access and switch to the LTM candidate cell.

The indication may be transmitted in a radio resource control message, in a MAC CE, in Layer 1 or Layer 2 signalling, and/or or in a PDCCH order.

The LTM configuration may include LTM candidate cell configurations for a plurality of LTM candidate cells, wherein the indication indicates which of the plurality of LTM candidate cells the UE should perform DL synchronization with.

Transmitting cell switch command may be performed after the UE performs DL pre-synchronization.

The UE may be configured with a plurality of LTM candidate cell configurations for a plurality of LTM candidate cells, wherein the LTM cell switch command is transmitted after the UE selects a subset of the LTM candidate cells for performing DL synchronization before.

The LTM cell switch command may correspond to a MAC Control Element, MAC CE, a Downlink Control Indication, DCI, a Layer 1, L1, signaling, a Layer 2, L2, signaling, and/or an L1/L2 signaling.

The LTM configuration may include one or more LTM candidate cell configurations to be applied upon reception of an LTM cell switch command.

The method may further include transmitting a configuration for timing alignment, TA, establishment/update with the LTM candidate cell to the UE prior to transmitting the LTM cell switch command indicating the LTM candidate cell.

The configuration for timing alignment may include a UL related parameter, a PRACH preamble configuration, a PRACH occasion, and/or a PRACH frequency resource.

### BRIEF DESCRIPTION OF THE DRAWINGS

FIG. 1 illustrates a timeline for L1/L2 inter-cell mobility.

FIG. 2 illustrates an example of a procedure for establishing timing alignment (TA).

FIG. 3 illustrates an example of DL pre-synchronization according to some embodiments.

FIG. 4 illustrates an example signaling flow according to some embodiments.

FIG. 5 illustrates a method performed by a UE in a wireless communication network for performing TA with a LTM candidate cell according to some embodiments.

FIG. 6 illustrates a method performed by a network node in a wireless communication network for L1/L2 based inter-cell mobility of a UE to a candidate cell according to some embodiments.

FIG. 7 shows an example of a communication system in accordance with some embodiments.

FIG. 8 shows an example of a UE in accordance with some embodiments.

FIG. 9 shows an example of a UE in accordance with some embodiments.

### DETAILED DESCRIPTION

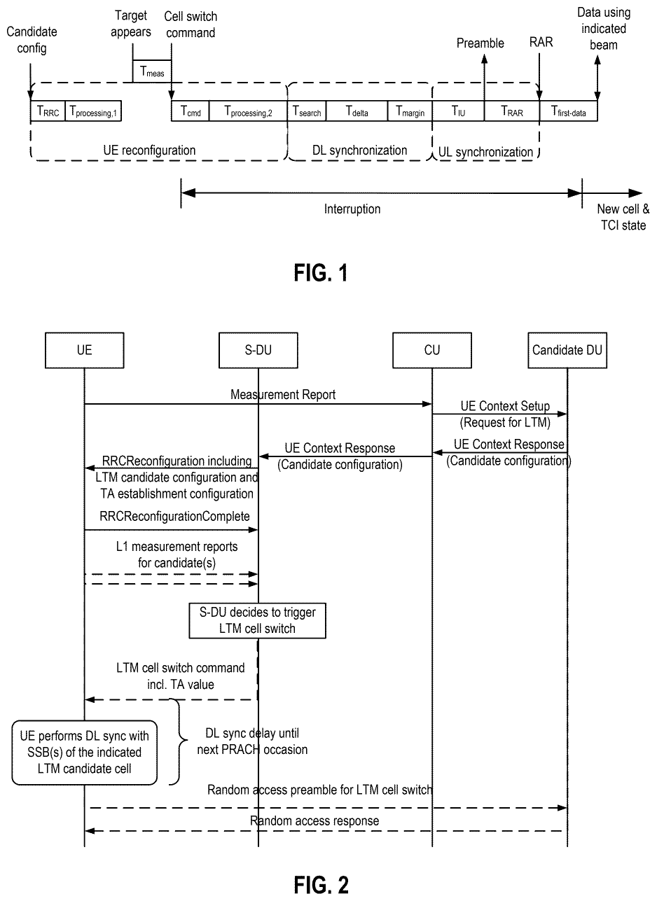

Two potential approaches and two timelines for LTM cell switch have been discussed, as shown in FIG. 1 and FIG. 2. In particular, FIG. 1 illustrates an agreed baseline timeline for L1/L2 inter-cell mobility, and FIG. 2 illustrates an example of an LTM cell switch procedure in which the UE accesses the LTM candidate cell in LTM cell switch in a Random Access procedure.

In LTM, an LTM cell switch procedure has been agreed in which the UE receives an LTM cell switch command (e.g., a medium access control, MAC, control element, CE, including an indication of one of the configured LTM candidate cells) and accesses the indicated LTM candidate cell. In one option, 3GPP assumes that the UE accesses the LTM candidate cell in response to the LTM cell switch command relies on a random access procedure i.e. when the UE receives the LTM cell switch command from a serving cell (e.g., PCell) the UE transmits a PRACH preamble to the LTM candidate cell and receives a Random Access Response (RAR). When the UE receives the LTM cell switch command, one of the steps the UE needs to perform which increases the delay to access the LTM candidate is the DL synchronization, in which the UE needs to perform fine time tracking and acquire full timing information of the LTM candidate cell, which is the target cell.

To further reduce the interruption time during the LTM cell switch, 3GPP has also agreed on another option, in which a Random Access procedure is not triggered in response to the LTM cell switch command, and instead, the UE transmits on a PUCCH and/or PUSCH of the LTM candidate cell indicated in the LTM cell switch command. While that reduces the delay inherent from the Random Access procedure, it requires the UE to be uplink (UL) synchronized with the LTM candidate cell indicated in the LTM cell switch command.

In some scenarios, the UE may be assumed to be UL synchronized with some LTM candidate cells, e.g., co-located cells with one or the serving cells the UE is configured with. In scenarios in which the serving cell(s) and the LTM candidate cells cannot be assumed to be UL synchronized, the UE may be configured to establish Time Alignment (TA) with one or more LTM candidate cells before the triggering of the LTM cell switch, for the establishment of UL synchronization, so that at the moment of the LTM cell switch the UE would not be required to trigger a Random Access procedure, and instead, the first UE action at the LTM candidate cell which becomes the target cell (i.e. the new PCell) is to monitor PDCCH and/or transmit an UL signal on PUCCH and/or PUSCH, which requires UL sync to be established.

There currently exist certain challenges. One challenge with the LTM cell switch procedure relying on a Random Access procedure is that before the UE transmits the PRACH preamble to the LTM candidate cell in response to the LTM cell switch command (e.g., a MAC CE indicating at least the LTM candidate cell), the UE needs to first perform a DL synchronization to one or more synchronization signal blocks (SSBs) of that LTM candidate cell so that the UE can transmit the PRACH preamble. That may take some time depending on various factors, such as the SSB periodicity (so that a next possible SSB takes longer to be received), or frequency range (e.g., FR2, mmWave frequencies), in which the UE would require more SSBs in a burst to be received for performing a beam sweeping, which also takes longer. In other words, DL synchronization upon LTM cell switch increases the LTM cells switch delay and consequently the mobility interruption time, which is being optimized in the study item in Rel-18. Because PRACH occasions and SSB(s) may be sparse (e.g., 10s of milliseconds), the procedure may be too slow.

Another potential issue in LTM cell switch is that the UE may be configured with multiple LTM candidate cells as the potential target cells. Based on the measurement reports from the UE, the NW may configure the UE to be switched to one of the candidate cells. Although the UE could measure multiple cells, the UE may not be able to maintain the DL synchronization with all the candidate cells as it may result in higher UE complexity and cost.

Certain aspects of the disclosure and their embodiments may provide solutions to these or other challenges. Some embodiments provide systems/methods for a user equipment (UE) to reduce the delay in an LTM cell switch procedure with an LTM candidate cell by performing DL synchronization (with one or more LTM candidate cells) based on one or more conditions/rules, before the reception of an LTM cell switch command. Then, when the UE receives the LTM Cell Switch command, the UE is already DL synchronized (or pre-synchronized). The UE may then transmit a PRACH preamble and/or data/control information on PUCCCH and/or PUSCH.

In some embodiments, a UE performs DL synchronization (which may also be called pre-synchronization or Downlink pre-synchronization) with an LTM candidate cell. The UE receives an LTM cell switch command (indicating an LTM candidate cell, e.g. LTM configuration ID) from a serving cell (e.g., a MAC CE from the Primary Cell, or Primary SCG cell) to access the LTM candidate cell. The UE transmits an UL signal to the LTM candidate cell in a configured UL channel resource(s) in time and frequency, such as a PRACH occasion, based on the DL synchronization performed before the reception of the LTM cell switch command. In some embodiments, the UE is configured with multiple LTM candidate cell(s) (i.e., more than one candidate cell) and selects a subset of the LTM candidate cell(s)/at least one LTM candidate cell for performing DL synchronization before it receives the LTM cell switch command. The selection of the subset of the LTM candidate cell(s) may be based on one or more rules (or combination of these). Multiple rules, which may possibly be combined, are proposed for the selection of the subset of the LTM candidate cell(s).

According to some embodiments, the LTM cell switch command may include an indication of the LTM candidate cell and an indication of one or more beams (e.g., SSB index and/or TCI state identifier) in which the UE is DL synchronized.

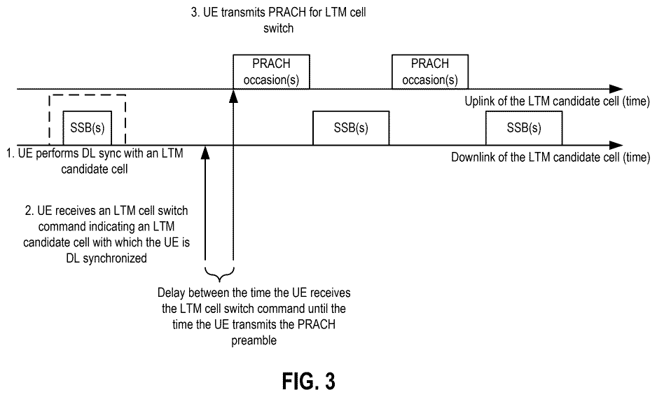

FIG. 3 illustrates an example embodiment. Referring to FIG. 3, at step 1, the UE performs DL sync with an LTM candidate cell. At step 2, the UE receives a LTM cell switch command indicating the LTM candidate cell to which the UE is DL synchronized. After a delay, the UE transmits at step 3 a PRACH preamble for LTM cell switch on a PRACH occasion before the next SSB, as the UE is already pre-synchronized to the candidate LTM cell.

Certain embodiments may provide one or more of the following technical advantage(s). In particular, the delay associated with an LTM cell switch procedure may be reduced, with or without a random access (RA) procedure.

The UE can transmit the UL signal (e.g., PRACH preamble) to the LTM candidate cell upon reception of the LTM cell switch command based on a pre-acquired DL synchronization. This may reduce the time it takes to perform the UL synchronization for an LTM candidate cell during the LTM cell switch, or, in case the UE is already UL synchronized (e.g., in case the UE has already obtained the TA value in the LTM cell switch command), the UE can transmit on UL faster. That may reduce the time the UE needs to start transmitting in the LTM candidate cell and/or monitor a Physical Downlink Control Chanel (PDCCH) in the DL.

Some of the embodiments contemplated herein will now be described more fully with reference to the accompanying drawings. Embodiments are provided by way of example to convey the scope of the subject matter to those skilled in the art.

The term “L1/L2 based inter-cell mobility” is used herein as it is used in the Work Item Description in 3GPP, and may be used interchangeably with the terms L1/L2 mobility, L1-mobility, L1 based mobility, L1/L2-centric inter-cell mobility, L1/L2 inter-cell mobility, or L1/L2 triggered Mobility (LTM).

The basic principle of LTM is that the UE is first configured with one or more LTM candidate cells (via RRC) and later, e.g., after the UE reports L1 measurements on one or more LTM candidate cells, the UE receives a lower layer signaling from the network indicating to the UE a change (or switch or activation) of its serving cell (e.g., change of PCell, from a source to a target PCell). A lower layer signaling is a message/signaling of a lower layer protocol, which may be referred as a L1/L2 inter-cell mobility execution command (or LTM cell switch command). The change of serving cell (e.g., change of PCell) may also lead to a change in SCell(s) for the same cell group, e.g., in case the command triggers the UE to change to another cell group configuration of the same type (e.g., another MCG configuration). Before the UE receives the LTM cell switch command, the UE is configured by the network with one or more LTM candidate cells (e.g., reception of an RRC Reconfiguration message, with at least one candidate cell configuration). A candidate cell configuration may include parameters in the IE CellGroupConfig per candidate cell and/or an embedded RRCReconfiguration per candidate cell.

A “lower layer protocol” refers to a lower layer protocol in the air interface protocol stack compared to the RRC protocol. For example, the Medium Access Control (MAC) is considered a lower layer protocol, as it is “below” RRC in the air interface protocol stack, and in this case a lower layer signaling/message may correspond to a MAC Control Element (MAC CE).

Another example of lower layer protocol is the Layer 1 (or Physical Layer, L1), and in this case a lower layer signaling/message may correspond to a Downlink Control Information (DCI). Signaling information in a protocol layer lower than RRC reduces the processing time and, consequently, reduces the interruption time during mobility. In addition, it may also increase the mobility robustness as the network may respond to faster changes in the channel conditions. Another relevant aspect in L1/L2 inter-cell mobility is that in multi-beam scenario, a cell can be associated to multiple SSBs, and during a half-frame, different SSBs may be transmitted in different spatial directions (i.e. using different beams, spanning the coverage area of a cell). Similar reasoning may be applicable to CSI-RS resources, which may also be transmitted in different spatial directions. Hence, in L1/L2 inter-cell mobility (LTM), the reception of a lower layer signaling indicates the UE to change from one beam in the serving cell, to another beam in a neighbour cell (which is a configured candidate cell), and by that changing serving cell.

The term “LTM cell switch procedure” (or simply cell switch) refers to the process of a UE changing its cell from a source cell to a target cell (which may be called here a candidate cell), using L1/L2-triggered mobility (also called here LTM). In the context of L1/L2 based inter-cell mobility or L1/L2-triggered mobility (LTM), LTM cell switch procedure may sometimes also be known as dynamic switch, LTM switch, (LTM) cell switch, (LTM) serving cell change or (LTM) cell change. Even if the term change of cell is used, that may comprise a change of a whole cell group configuration, which includes a change in the SpCell (e.g., change of PCell, or change of PSCell) and a change in SCells of the cell group (e.g., addition, modification and/or release of one or more SCells).

The term “LTM candidate cell” refers to a cell to which the UE can move in a L1/L2 inter-cell mobility procedure, upon reception of a lower layer signaling. These cells may also be called candidate cells, candidates, mobility candidates, non-serving cells, additional cells, etc. This is a cell the UE perform measurements on (e.g., L1-RSRP measurements or CSI measurements) as disclosed herein, so that the UE reports these measurements and network may take educated decision on which beam (e.g., TCI state) and/or cell the UE is to be switched to. A L1/L2 inter-cell mobility candidate cell may be a candidate to be a target PCell or PSCell, or an SCell of a cell group (e.g., MCG SCell). In that sense, when the text refers to a resource configuration to indicate SSs and/or RSs for the UE to measure for CSI for reporting, it may be referring to SSs and/or RSs of a candidate SCell of the MCG, a candidate SCell of the SCG, a candidate PSCell and/or a candidate PCell.

According to some embodiments, related to LTM, a UE may be capable of acquiring Downlink (DL) and/or Uplink (UL) synchronization before receiving the LTM cell switch command (e.g., MAC CE indicating an LTM candidate cell and/or LTM candidate cell configuration). For a UE which is capable of acquiring DL synchronization before receiving the LTM cell switch command, there may be limitation on the number of cells the UE can acquire such a synchronization before receiving the LTM cell switch command. Also, for acquiring the UL synchronization, the UE needs to transmit UL signals such as PRACH preamble or Sounding Reference Signal (SRS) to the LTM candidate cell (e.g., of a target gNB and/or Candidate DU). Unless the UE has acquired DL synchronization, the UE does not transmit PRACH or SRS to acquire the UL synchronization. Each PRACH preamble may be associated with an SSB and a RACH occasion (RO) where the preamble can be transmitted. The RO can be a periodically repeating occasion. For example, a first RO associated with a PRACH preamble is at 10 ms, then the 2nd RO associated with the same preamble may be at 10 ms+(160 ms) and 3rd RO associated with the same preamble may be at 10 ms+(2*160 ms), and the 4th RO is 10 ms+3*160 ms, etc.

In some embodiments, a method includes the UE performing DL synchronization (which may also be called pre-synchronization or Downlink pre-synchronization) with an LTM candidate cell. The UE receives an LTM cell switch command from a serving cell (e.g., a MAC CE from the Primary Cell, or Primary SCG cell) indicating the switching to the LTM candidate cell (e.g., by including an LTM candidate ID or LTM candidate configuration ID). The UE transmits the UL signal to the LTM candidate cell in a configured UL channel resource(s) in time and frequency, such as a PRACH occasion, based on the DL synchronization performed before the reception of the LTM cell switch command.

According to some embodiments, the LTM cell switch command may correspond to a MAC Control Element (MAC CE) or a Physical Downlink Control Channel (PDCCH) order/command or indication, wherein the trigger is received from the Primary Cell (e.g., PCell, PSCell, SpCell) triggering the UE to access the LTM candidate cell and change its configuration.

The UL signal may correspond to a Physical Random Access Channel (PRACH) preamble, transmitted to an UL channel of the LTM candidate cell, wherein the UL channel of the LTM candidate cell comprises a PRACH. In some embodiments, the UL signal may correspond to a Sounding Reference Signal transmitted to an UL channel of the LTM candidate cell configured for SRS transmission (e.g., PUCCH/PUSCH). In other embodiments, the UL signal may correspond to control information (e.g., scheduling request) to an UL channel of the LTM candidate cell, wherein the UL channel of the LTM candidate cell comprises Physical Uplink Control Channel (PUCCH). In further embodiments, the UL signal may correspond to UL data (e.g., payload which includes an RRCReconfigurationComplete) transmitted to an UL channel of the LTM candidate cell, wherein the UL channel of the LTM candidate cell comprises Physical Uplink Shared Channel (PUSCH).

Prior to receiving the LTM cell switch command from the serving cell indicating the LTM candidate cell, the UE may receive a configuration (e.g., an LTM configuration within an RRC Reconfiguration message) from the serving cell with one or more LTM candidate cell configuration(s), to be applied upon reception of an LTM cell switch command. This is equivalent to the UE being configured with LTM by the network.

In some embodiments, prior to receiving the LTM cell switch command from the serving cell indicating the LTM candidate cell, the UE may receive a configuration for TA establishment/update with the LTM candidate cell, comprising one or more UL related parameters: such as PRACH preamble configuration, PRACH occasion(s), PRACH frequency resource(s), etc. In one option, the configuration for TA establishment/update is included in the same RRC message configuring the UE with LTM, e.g., an RRC Reconfiguration. In another option, the configuration for TA establishment/update is included in a second RRC message while the UE receives a first RRC message configuring the UE with LTM, e.g., a second RRC Reconfiguration.

In some embodiments, the UE performs a TA establishment procedure by transmitting a PRACH preamble to at least one LTM candidate cell (so the network, e.g., a Candidate DU, calculates a Timing Advance value). When the UE receives the LTM cell switch command indicating the LTM candidate cell the UE needs to switch to, that LTM cell switch command also includes the TA value. Based on the DL synchronization with the LTM candidate cell, acquired by the UE before the reception of the LTM cell switch command, the UE applies the TA value and obtains UL synchronization.

According to some embodiments, the UE is configured with multiple LTM candidate cell(s) (i.e., more than one candidate cell) and selects a subset of the LTM candidate cell(s)/at least one LTM candidate cell for performing DL synchronization before a TA establishment procedure is triggered. The selection of the subset of the LTM candidate cell(s) may be based on one or more rules (or combination of these).

According to some embodiments, the UE is configured with multiple LTM candidate cell(s) (i.e., more than one candidate cell) and selects a subset of the LTM candidate cell(s)/at least one LTM candidate cell for performing DL synchronization before an LTM cell switch (i.e. before the reception of the LTM cell switch command). The selection of the subset of the LTM candidate cell(s) is based on one or more rules (or combination of rules). The rules may include, for example:

Rule 1) The UE selects all LTM candidate cell(s) which the UE is configured with, when the number of LTM candidate cell(s) do not exceed a UE capability corresponding to a maximum number of cells in which the UE is capable of performing DL sync before LTM cell switch.

For example, when the UE reports a capability which indicates that the UE is capable of performing DL synchronization before LMT cell switch with a number “K” of LTM candidate cells and the UE receives a message (e.g., RRC Reconfiguration) including an LTM configuration for a number K* LTM candidate cells with K*<=K, the UE performs DL sync to all configured LTM candidate cell(s) after receiving the LTM candidate cell configuration and before the LMT cell switch is triggered, e.g., before the reception of the LMT cell switch command.

The capability described above may be reported when the UE transitions from IDLE to CONNECTED state.

Rule 2) The UE selects the LTM candidate cell(s) with a measurement quantity (e.g., RSRP) above a threshold, e.g., the UE selects the LTM candidate cell(s) with RSRP above a threshold.

In one option the threshold is configurable, e.g., per LTM candidate cell, or per LTM configuration (applicable for multiple/all LTM candidate cell(s)). In other words, the UE may receive an RRC Reconfiguration message including that threshold.

In one option, the measurement quantity (e.g., RSRP, RSRQ, SINR) is configurable.

In one option, the measurement quantity is a cell based measurement quantity, e.g., a cell RSRP for the LTM candidate cell.

In one option, the measurement quantity is a beam/SSB/CSI-RS based measurement quantity. For example, the UE selects the cells whose strongest SS-RSRP is above the threshold.

In one option, this rule may be combined with the rule 1) as follows: the UE selects the LTM candidate cell whose measurement quantity (e.g., RSRP) is above a threshold, when the number of LTM candidates whose measurement quantity above the threshold do not exceed the maximum number of LTM candidate cells the UE is capable of performing DL sync before the reception of the LTM cell switch command.

Rule 3) The UE selects “K” strongest LTM candidate cells out of “N” configured LTM candidate cells according to a measurement quantity, wherein a measurement quantity may correspond to RSRP, RSRQ, SINR, etc.

In one option, the UE reports a capability which indicates that the UE is capable of performing DL synchronization before the reception of the LMT cell switch command, with a number “K” of LTM candidate cells and the UE receives a message (e.g., RRC Reconfiguration) including an LTM configuration for a number “N” LTM candidate cells with N>K, so that the UE performs DL sync to the K strongest LTM candidate cell(s) for a measurement quantity, after receiving the LTM candidate cell configuration and before the reception of the LTM cell switch command.

In one option, the measurement quantity (e.g., RSRP, RSRQ, SINR) is configurable.

In one option, the maximum number of LTM candidate cells for which the UE establishes DL sync before the reception of the LTM cell switch command is configurable, e.g., a parameter received in an RRC Reconfiguration.

In one option, the K strongest LTM candidate cells is selected based on the cell quality of the LTM candidate cell, e.g., UE selects the LTM candidates whose cell RSRP values are the strongest.

In one option, the K strongest LTM candidate cells is selected based on a beam/SSB/CSI-RS quality of the LTM candidate cell, e.g., UE selects the LTM candidates whose strongest beam level RSRP values (SS-RSRP values) are the strongest.

Rule 4) The UE selects all LTM candidate cell(s) configured for TA establishment/update, e.g., upon reception of the RRC message including the TA establishment configuration, when the number of LTM candidate cell(s) configured for TA establishment/update do not exceed a UE capability corresponding to a maximum number of cells in which the UE is capable of performing DL sync before reception of the LTM cell switching.

For example, when the UE reports a capability which indicates that the UE is capable of performing DL synchronization with a number “K” of LTM candidate cells, before reception of the LTM cell switch command, and the UE receives a message (e.g., RRC Reconfiguration) including an LTM configuration including the TA establishment configuration for a number K* of LTM candidate cells with K*<=K, the UE performs DL sync to all configured LTM candidate cell(s) (configured for TA establishment) after receiving the LTM candidate cell configuration and before the reception of the LTM cell switch command.

The LTM candidate cells which are also configured for TA establishment are cells the UE will obtain a TA value before the LTM cell switch, so that the UE would be able to transmit on PUCCH and/or PUSCH (i.e. no need to access the LTM candidate cell via random access). Thus, performing DL sync with these cells may speed up the access of the LTM candidate cells when transmitting on PUCCH and PUSCH, or when monitoring PDCCH in the LTM candidate cell.

The capability described above may be reported when the UE transitions from IDLE to CONNECTED state.

Rule 5) The UE selects the LTM candidate cell(s) configured for TA establishment/update with a measurement quantity (e.g., RSRP) above a threshold, e.g., the UE selects the LTM candidate cell(s) configured for TA establishment with RSRP above a threshold.

In one option the threshold is configurable, e.g., per LTM candidate cell, or per LTM configuration (applicable for multiple/all LTM candidate cell(s)), possibly in parts of the TA establishment/update configuration or the LTM configuration. In other words, the UE may receive an RRC Reconfiguration message including the configuration for performing TA establishment/update which includes that threshold.

In one option, the measurement quantity (e.g., RSRP, RSRQ, SINR) is also configurable.

In one option, the measurement quantity is a cell based measurement quantity, e.g., a cell RSRP for the LTM candidate cell.

In one option, the measurement quantity is a beam/SSB/CSI-RS based measurement quantity. For example, the UE selects the cells whose strongest SS-RSRP is above the threshold.

In one option, this rule may be combined with the Rule 4).

The LTM candidate cells which are also configured for TA establishment are cells the UE will obtain a TA value before the LTM cell switch, so that the UE would be able to transmit on PUCCH and/or PUSCH (i.e. no need to access the LTM candidate cell via random access). Thus, performing DL sync with these cells may speed up the access of the LTM candidate cells when transmitting on PUCCH and PUSCH, or when monitoring PDCCH in the LTM candidate cell.

Rule 6) The UE selects “K” strongest LTM candidate cells configured for TA establishment out of “N” configured LTM candidate cells configured for TA establishment according to a measurement quantity, wherein a measurement quantity may correspond to RSRP, RSRQ, SINR, etc.

In one option, the UE reports a capability which indicates that the UE is capable of performing DL synchronization with a number “K” of LTM candidate cells configured for TA establishment, before the reception of the LTM cell switch command, and the UE receives a message (e.g., RRC Reconfiguration) including an LTM configuration for a number “N” LTM candidate cells with N>K, so that the UE performs DL sync to the K strongest LTM candidate cell(s) for a measurement quantity, after receiving the LTM candidate cell configuration and before the reception of the LTM cell switch command.

In one option, the measurement quantity (e.g., RSRP, RSRQ, SINR) is configurable.

In one option, the maximum number of LTM candidate cells for which the UE establishes DL sync before the reception of the LTM cell switch command is configurable, e.g., a parameter received in an RRC Reconfiguration.

In one option, the K strongest LTM candidate cells is selected based on the cell quality of the LTM candidate cell, e.g., UE selects the LTM candidates whose cell RSRP values are the strongest.

In one option, the K strongest LTM candidate cells is selected based on a beam/SSB/CSI-RS quality of the LTM candidate cell, e.g., UE selects the LTM candidates whose strongest beam level RSRP values (SS-RSRP values) are the strongest.

Rule 7) The UE selects one or more LTM candidate cell(s) based on an indication or configuration received from the network, wherein the indication indicates which LTM candidate the UE needs to perform DL synchronization before the reception of the LTM cell switch command.

In one option, the indication is received in an RRC Reconfiguration message, e.g., as part of the LTM configuration (e.g., per candidate), or as part of the TA establishment/update configuration, which for a given candidate includes an indication that the LTM candidate is a candidate for which the UE performs DL sync the reception of the LTM cell switch command.

In one option, the indication is received in a MAC CE (or other form or lower layer protocol signaling), e.g., received after the reception of the LTM candidate configuration, but before the reception of the LTM cell switch command.

In one option, the indication is received in a Layer 1 (L1) signaling, e.g., in a DL physical channel.

In one option, the indication is received in a Layer 1/Layer 2 (L1/L2) signaling.

In one option, the indication is received in a PDCCH order.

In one option, the UE receives an RRC configuration including an indication of which of the LTM candidate cells the UE is to perform DL sync before the reception of the LTM cell switch command. The indication may indicate a subset of the LTM candidate cells, or a subset of the candidate cells configured for TA establishment.

For example, the UE is configured with LTM candidates A, B, C, D, but only A and B are configured for DL sync before the reception of the LTM cell switch command.

In one option, the network indicates an LTM candidate cell to the UE for DL sync based on one or more measurements reported by the UE.

For example, the UE transmits one or more L1 measurements for an LTM candidate cell, so that the network (e.g., the CU, the S-DU) determines that the reported LTM candidate cell is a cell the network wants the UE to perform DL sync before the reception of the LTM cell switch command.

Rule 8) The UE selects one or more LTM candidate cell(s) based on latest L1 measurement reports, e.g., SS-RSRP of an LTM candidate cell which has been reported.

In one option, the UE is configured to perform L1 measurements on one or more LTM candidate cells, e.g., CSI measurements, SS-RSRP measurements, etc. Then, the UE selects the LTM candidate cells to perform DL sync as the cells for which the UE has transmitted the L1 reports. The reasoning could be that these are also the LTM candidate cells which are more likely to be selected by the network (e.g., S-DU) for LTM cell switch.

In one option, this feature is configured.

In one option, the UE does that with a number of LTM candidate cells before its capability is exceeded, e.g., the UE reports a number of cells up to the number of LTM candidate cells in which the UE can perform DL sync before the reception of the LTM cell switch command.

In one option, the UE updates the LTM candidate cells in which the UE performs DL sync, depending on the cells which are being reported.

Rule 9) The UE selects one or more LTM candidate cell(s) based on L3 measurements, e.g., cell based RSRP of an LTM candidate cell.

In one option, the UE is configured to perform L3 measurements on one or more LTM candidate cells, e.g., Radio Resource Management (RRM) measurements like L3 filtered cell based RSRP, RSRQ, SINR. Then, the UE selects the LTM candidate cells to perform DL sync as the cells for which the UE has transmitted a L3 measurement report, e.g. triggered cells, fulfilling the condition(s) of an event configured in the reporting configuration, e.g., A3 or A5 event. The reasoning could be that these triggered cells fulfilling the event(s) may be configured as LTM candidate cells by the network and be selected by the network (e.g., S-DU) for LTM cell switch.

In one option, this feature is configured.

In one option, the UE does that with a number of neighbour cells (e.g., which are triggered cells) before its capability is exceeded, e.g., the UE reports a number of cells up to the number of LTM candidate cells in which the UE can perform DL sync before the reception of the LTM cell switch command.

In one option, the UE updates the neighbour cells (e.g., triggered cells) in which the UE performs DL sync, depending on the cells which are being reported.

Rule 10) The UE selects at least one LTM candidate cell(s) for which TA had been established but have been lost.

In one option, the UE performs DL sync for an LTM candidate cell and receives the trigger for transmitting the UL signal (e.g., PRACH preamble). The UE may start a Time Alignment timer (or equivalent timer), so that while the timer is running the UE considers itself to be UL synchronized with that LTM candidate cell. When that timer expires, the UE re-starts the action of obtaining DL sync with that LTM candidate cell, as the network (e.g., S-DU) may select that cell for LTM cell switch and, if that occurs, the UE is ready to perform a faster random access procedure as it is already DL synchronized.

Rule 11) UE selects cells in higher frequencies and/or in a specific frequency range, e.g., FR2 cells, as these could take longer to synchronized.

In one option, the UE performs DL sync for an LTM candidate cell (or a subset of the LTM candidate cells) whose SSB(s) are in a high frequencies and/or in a specific frequency range (FR2). The reasoning is that for these cells, it may take longer to obtain DL sync so that if the UE waits for the trigger to transmit the UL signal in LTM cell switch and first needs to perform DL sync, it would take too long.

Rule 12) UE selects cells with “long” SSB periodicity, because UE knows these may take longer to sync.

In one option, the UE performs DL sync for an LTM candidate cell (or a subset of the LTM candidate cells) whose SSB(s) are with long periodicity, e.g., above 20 ms.

In one option, the long periodicity is configured (e.g., periodicity threshold), so that the UE perform DL sync to cells with periodicity longer than the configured value.

According to some embodiments, the one or more rules may be based on one or more parameters the UE is configured with. In some of the rules above, examples of parameter(s) have been provided. The UE may receive the configuration of the one or more parameters in an RRC Reconfiguration message, wherein the one or more parameters may be set for one or more LTM candidate cell(s).

An example of a signaling flow for the method is shown below, with some of the steps also performed by network nodes involved, such as the Source DU (S-DU), the Central Unit (CU) and the Candidate DU (C-DU):

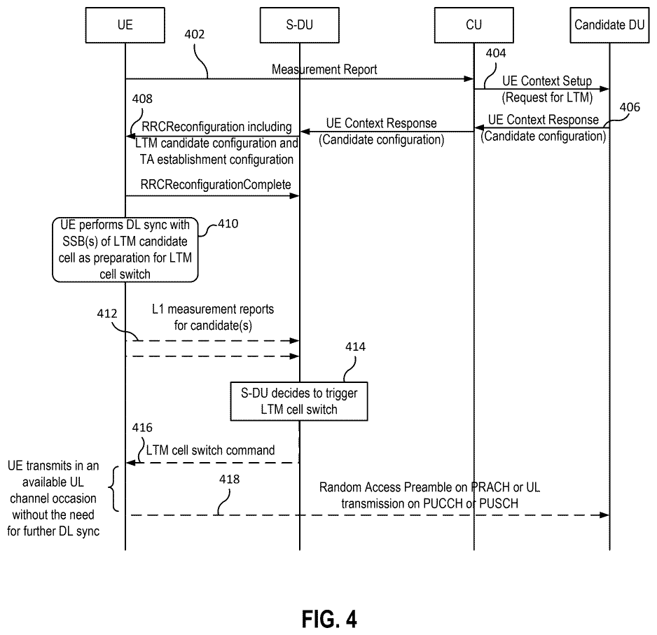

FIG. 4 illustrates an example of a signaling flow in accordance with some embodiments. Referring to FIG. 4, a UE transmits a measurement report 402 to a network node, and in particular to a CU of a network node, containing requested measurements. The measurements may include measurements of a cell of associated with a candidate DU. The CU determines to configure the UE to perform an LTM procedure by the UE towards the candidate DU. The CU sends a UE context setup request 404 to the candidate DU requesting LTM of the UE towards the candidate DU. The candidate DU responds with a UE context response 406 including a candidate LTM configuration to be provided to the UE. The serving CU/DU then transmits an RRCReconfiguration message 408 to the UE including an LTM candidate configuration for the candidate DU.

After replying to the CU/DU with an RRCReconfigurationComplete, and before TA establishment, the UE performs DL synchronization with the candidate cell at block 410 as preparation for TA establishment.

The UE may provide L1 measurement reports 412 for the candidate cell to the CU/DU. The serving CU/DU then determines to trigger an LTM cell switch at block 414, and sends an LTM cell switch command 416 to the UE. The UE then transmits a UL transmission 418 in the candidate cell without the need for further DL synchronization.

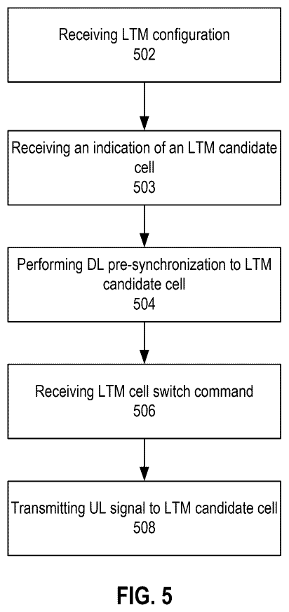

FIG. 5 illustrates a method by a user equipment (UE) for performing an L1/L2 based inter-cell mobility, LTM, cell switch with an LTM candidate cell. The method includes receiving an LTM configuration including an LTM candidate cell configuration (block 502), receiving an indication of an LTM candidate cell with which the UE is to perform DL pre-synchronization (block 503), and performing downlink, DL, pre-synchronization with the LTM candidate cell (block 504). The UE receives an LTM cell switch command from a serving cell indicating that the UE needs to access and switch to the LTM candidate cell (block 506), and transmits, in response to the trigger, an uplink, UL, signal to the LTM candidate cell (block 508).

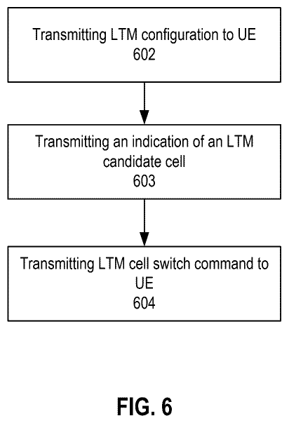

FIG. 6 illustrates a method by a network node for causing a user equipment (UE) to perform an L1/L2 based inter-cell mobility, LTM, cell switch with an LTM candidate cell. The method includes transmitting an LTM configuration including an LTM candidate cell configuration to cause the UE to perform downlink, DL, pre-synchronization with the LTM candidate cell (block 602), and transmitting an indication of an LTM candidate cell with which the UE is to perform DL pre-synchronization (block 603). The network node transmits an LTM cell switch command to the UE indicating that the UE needs to access and switch to the LTM candidate cell (block 604).

The UE performing DL synchronization (also called DL pre-synchronization, pre-synchronization, pre-sync) with an LTM candidate cell comprises the UE detecting and/or measuring at least one synchronization signal of the LTM candidate cell, such as an Synchronization Signal Block (SSB), e.g., an SSB of the LTM candidate cell associated to an SSB index and/or identifier and transmitted in a spatial direction (beam), and/or a Channel State Information—Reference Signal (CSI-RS) and/or a Tracking Reference Signal (TRS) and/or a Primary Sync Signal (PSS) and/or a Secondary Sync Signal (SSS); in this context, measuring comprises determining a measurement quantity value such as a Synchronization Signal based Reference Signal Received Power (SS-RSRP) and/or Synchronization Signal based Reference Signal Received Quality (SS-RSRQ) and/or Synchronization Signal based Signal to Noise and Interference Ratio (SS-SINR).

The UE performing DL synchronization with an LTM candidate cell comprises the UE performing fine time tracking and acquiring full timing information of the LTM candidate cell. Timing acquisition comprises obtaining the time boundaries of time units of a given LTM candidate cell such as time slot, OFDM symbol, subframe, radio frame. Timing acquisition comprises synchronizing a clock with the boundaries of time units of a given LTM candidate cell such as time slot, OFDM symbol, subframe, radio frame. The acquired fine timing is used as reference point for PRACH transmission and UE uplink transmissions.

In some embodiments, according to the method, after the UE obtains DL sync with one or more LTM candidate cells, the UE starts a timer (e.g., configured with a timer value in the RRC configuration). While the timer is running the UE is required to keep the DL synchronization, e.g., the UE may need to perform further measurements and/or obtain timing information. When the timer expires, the UE is not required to maintain DL sync with that LTM candidate cell(s). When the UE receives the LTM cell switch command, the UE stops the timer. Similar functionality could be achieved by the UE counting a number of SSB occasions (e.g., configured with a timer value in the RRC configuration) or counting a number of PRACH occasions. The timer value for such a timer may be configured by the network to the UE, e.g., received in an RRC Reconfiguration.

In some embodiments, according to the method, after the UE obtains DL sync a first and a second LTM candidate cells, the UE starts a timer (e.g., configured with a timer value in the RRC configuration). While the timer is running the UE is required to keep the DL synchronization with both candidates, e.g., the UE may need to perform further measurements and/or obtain timing information. When the timer expires, the UE is not required to maintain DL sync with these LTM candidate cell(s). When the UE receives the LTM cell switch command indicating the first LTM candidate cell, the UE stops the timer for that first LTM candidate cell, but keeps the timer running for the second LTM candidate cell, so that when the UE is in the first LTM candidate cell (after the switch) the timer is still running for the second LTM candidate, which is a cell for which the UE is required to maintain DL sync. In another alternative, when the UE receives the LTM cell switch command indicating the first LTM candidate cell, the UE stops the timer for that first LTM candidate cell, and for the second LTM candidate cell.

In some embodiments, the UE receives an RRC message (e.g., from the NW node) configuring lower layer measurements (also called as beam measurement) of one or more LTM candidate cells, and perform one or more of the following steps before receiving the LTM cell switch command:

Performing measurements on the group of N1 cells (group 1) that are configured as LTM candidate cells; and acquiring and maintaining the DL synchronization to at least a group of N2 cells (group 2) among the configured cells (group 1 or N1 cells). In other words, the UE performs DL sync for a first subset of LTM candidate cells the UE is being configured with.

Receiving a request (sig1) from NW node (e.g., from a cell1) for transmission of UL synchronization signal (sig2) to the LTM candidate cell (cell2), for LTM cell switch.

Determining the transmission occasion of the sig2 (e.g., PRACH occasion/RACH occasion) to the LTM candidate cell 2 with respect to the sig1, where:

In some embodiments, sig1 may be a PDCCH order. In some other embodiments sig1 may be a MAC CE message or RRC message.

In some embodiments sig2 may be PRACH preamble. In some other embodiments sig2 may be SRS. In some other embodiments UL synchronization signal may be a signal specially designed for acquiring UL synchronization.

In some examples if the sig2 is PRACH preamble, PRACH is configured with multiple RACH occasions.

In some embodiments, if the cell2 belong to group 2, the transmission occasion of the sig2 is the first transmission occasion configured for transmission of sig2.

In some embodiments, the number of cells (N2) (i.e., the number of cells UE could maintain DL synchronization) in group 2 is indicated as a UE capability, which is reported to the network by the UE, e.g., during a transition from IDLE to CONNECTED states.

In some examples, N2 may be a fixed value, e.g., specified in 3GPP specification.

In some other embodiments N2 may be signaled to the UE by NW and in this case N1 can be a configurable parameter through RRC message or MAC message or DCI message.

In some other embodiments N2 may be signaled from the UE to the network. In such a case, the network may ensure that N1 is equal to N2 in order to not exceed the UE capability.

In one alternative, the network may configure N1 to be greater than N2 and it may indicate separately with N2 cells the UE should keep the pre-sync.

In one alternative, the network may configure N1 to be greater than N2 and leave to the UE how to select the N2 cells to which to keep the pre-sync.

In one alternative, the network may configure N2 to be lower with respect to the maximum N2 that is supported by the UE (according to its capabilities).

The method further comprises the UE determining which N2 cells UE maintains synchronization among the configured N1 cells. In some embodiments, the N2 cells in group 2 are the N2 strongest cells from the N1 cells in group 1. In some examples, the strongest N2 cells are determined based on the signal strength measured at UE, where the signal strength may be dependent on the measurement quantity configured for the UE. In some examples, measurement quantity may be RSRP (e.g., L1-RSRP or L3-RSRP or SS-RSRP or CSI-RS-RSRP.) or RSRQ or SINR.

In some embodiments, UE acquires and maintains DL synchronization using any synchronization signals (e.g., SSB) or any tracking signals (e.g., tracking reference signal, TRS) or combination of both SSB and TRS. UE may further acquire DL synchronization from SSB or TRS using correlation or matched filter approach or any proprietary algorithm.

In some embodiments, the UE maintains the DL synchronization to all the cells in group 2 also after the transmission of the UL synchronization signal. In other embodiments, the UE maintains the DL synchronization to a subset of the cells in group 2 after the transmission of the UL synchronization signal. In one embodiment, the UE maintains the DL synchronization only to cell2 after the transmission of the UL synchronization signal.

In some embodiments, the network provides the UE with N1 LTM candidate cells and requests the UE to perform DL pre-sync with all of them (therefore N1 equal to N2). However, the UE performs the pre-sync only with N3 LTM candidate cell and, in this case, it reports the number N3 and an identification for each of the N3 LTM candidate cell. In this case, the identification may be one or a combination of.
a LTM candidate cell configuration identifier (ID);
a serving cell ID that is included within the LTM candidate cell configuration ID;
a Transmission configuration indication (TCI) state ID;
a beam ID
a measurement ID

The reason on why the UE may decide to do a pre-sync only with N3 LTM candidate cell may be due to capabilities limitation, due to signal strength measured with starting to perform the pre-sync, geographical location, or other UE-implementation specific criteria.

This is evidence that the UE is pre-synchronized with the LTM candidate cell in the DL, otherwise the UE would require much longer to transmit the message in the UL channel, being able to only send after the N-th UL resource which is configured.

In some embodiments, the UE receives a configuration of one or more LTM candidate cells, then, the UE performs DL sync with an LTM candidate cell, and the UE receives the LTM cell switch command indicating the LTM candidate cell and in response to the LTM cell switch command, the UE receives information on a DL control channel (e.g., PDCCH) occasion (e.g., a given frame/subframe/time-slot/one or more OFDM symbols), such as a Downlink Control Indication (DCI) based on the obtained DL sync. That DCI indicates a DL data channel (e.g., PDSCH) with downlink data, so that in response the UE needs to transmit a HARQ feedback. To transmit that HARQ feedback the UE transmits the scheduling request on PUCCH. Or, in more general terms, in response to the DL control information the UE transmits an UL signal (e.g., HARQ control information) to an UL channel (e.g., PUCCH) to the LTM candidate cell, wherein the UL signal comprise a scheduling request for transmitting a Hybrid Automatic Repeat Request (HARQ) feedback.

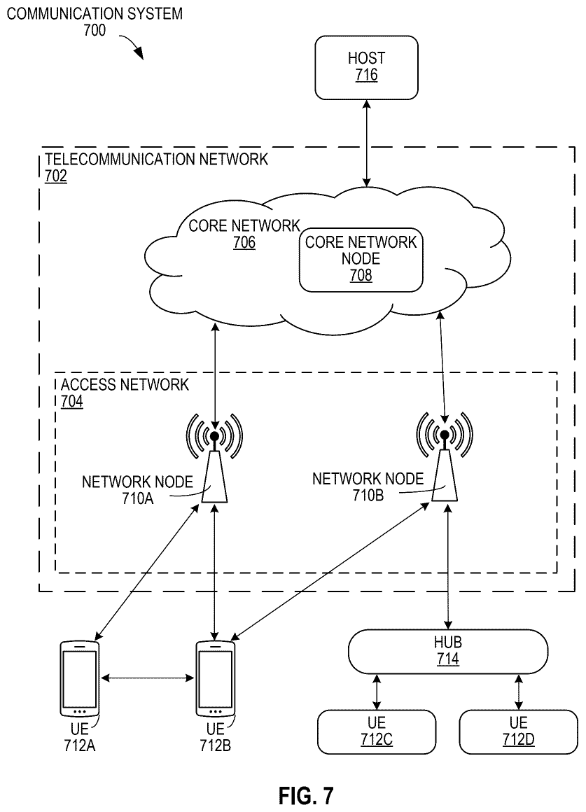

FIG. 7 shows an example of a communication system 700 in accordance with some embodiments.

In the example, the communication system 700 includes a telecommunication network 702 that includes an access network 704, such as a radio access network (RAN), and a core network 706, which includes one or more core network nodes 708. The access network 704 includes one or more access network nodes, such as network nodes 710a and 710b (one or more of which may be generally referred to as network nodes 710), or any other similar 3^{rd} Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 702 includes one or more Open-RAN (ORAN) network nodes. An ORAN network node is a node in the telecommunication network 702 that supports an ORAN specification (e.g., a specification published by the O-RAN Alliance, or any similar organization) and may operate alone or together with other nodes to implement one or more functionalities of any node in the telecommunication network 702, including one or more network nodes 710 and/or core network nodes 708.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 710 facilitate direct or indirect connection of user equipment (UE), such as by connecting UEs 712a, 712b, 712c, and 712d (one or more of which may be generally referred to as UEs 712) to the core network 706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 700 may include any number of wired or wireless networks, network nodes, UEs, and/or any other components or systems that may facilitate or participate in the communication of data and/or signals whether via wired or wireless connections. The communication system 700 may include and/or interface with any type of communication, telecommunication, data, cellular, radio network, and/or other similar type of system.

The UEs 712 may be any of a wide variety of communication devices, including wireless devices arranged, configured, and/or operable to communicate wirelessly with the network nodes 710 and other communication devices. Similarly, the network nodes 710 are arranged, capable, configured, and/or operable to communicate directly or indirectly with the UEs 712 and/or with other network nodes or equipment in the telecommunication network 702 to enable and/or provide network access, such as wireless network access, and/or to perform other functions, such as administration in the telecommunication network 702.

In the depicted example, the core network 706 connects the network nodes 710 to one or more hosts, such as host 716. These connections may be direct or indirect via one or more intermediary networks or devices. In other examples, network nodes may be directly coupled to hosts. The core network 706 includes one more core network nodes (e.g., core network node 708) that are structured with hardware and software components. Features of these components may be substantially similar to those described with respect to the UEs, network nodes, and/or hosts, such that the descriptions thereof are generally applicable to the corresponding components of the core network node 708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 716 may be under the ownership or control of a service provider other than an operator or provider of the access network 704 and/or the telecommunication network 702, and may be operated by the service provider or on behalf of the service provider. The host 716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 700 of FIG. 7 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 702 is a cellular network that implements 3GPP standardized features. Accordingly, the telecommunications network 702 may support network slicing to provide different logical networks to different devices that are connected to the telecommunication network 702. For example, the telecommunications network 702 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 712 are configured to transmit and/or receive information without direct human interaction. For instance, a UE may be designed to transmit information to the access network 704 on a predetermined schedule, when triggered by an internal or external event, or in response to requests from the access network 704. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub 714 communicates with the access network 704 to facilitate indirect communication between one or more UEs (e.g., UE 712c and/or 712d) and network nodes (e.g., network node 710b). In some examples, the hub 714 may be a controller, router, content source and analytics, or any of the other communication devices described herein regarding UEs. For example, the hub 714 may be a broadband router enabling access to the core network 706 for the UEs. As another example, the hub 714 may be a controller that sends commands or instructions to one or more actuators in the UEs. Commands or instructions may be received from the UEs, network nodes 710, or by executable code, script, process, or other instructions in the hub 714. As another example, the hub 714 may be a data collector that acts as temporary storage for UE data and, in some embodiments, may perform analysis or other processing of the data. As another example, the hub 714 may be a content source. For example, for a UE that is a VR headset, display, loudspeaker or other media delivery device, the hub 714 may retrieve VR assets, video, audio, or other media or data related to sensory information via a network node, which the hub 714 then provides to the UE either directly, after performing local processing, and/or after adding additional local content. In still another example, the hub 714 acts as a proxy server or orchestrator for the UEs, in particular if one or more of the UEs are low energy IoT devices.

The hub 714 may have a constant/persistent or intermittent connection to the network node 710b. The hub 714 may also allow for a different communication scheme and/or schedule between the hub 714 and UEs (e.g., UE 712c and/or 712d), and between the hub 714 and the core network 706. In other examples, the hub 714 is connected to the core network 706 and/or one or more UEs via a wired connection. Moreover, the hub 714 may be configured to connect to an M2M service provider over the access network 704 and/or to another UE over a direct connection. In some scenarios, UEs may establish a wireless connection with the network nodes 710 while still connected via the hub 714 via a wired or wireless connection. In some embodiments, the hub 714 may be a dedicated hub—that is, a hub whose primary function is to route communications to/from the UEs from/to the network node 710b. In other embodiments, the hub 714 may be a non-dedicated hub—that is, a device which is capable of operating to route communications between the UEs and network node 710b, but which is additionally capable of operating as a communication start and/or end point for certain data channels.

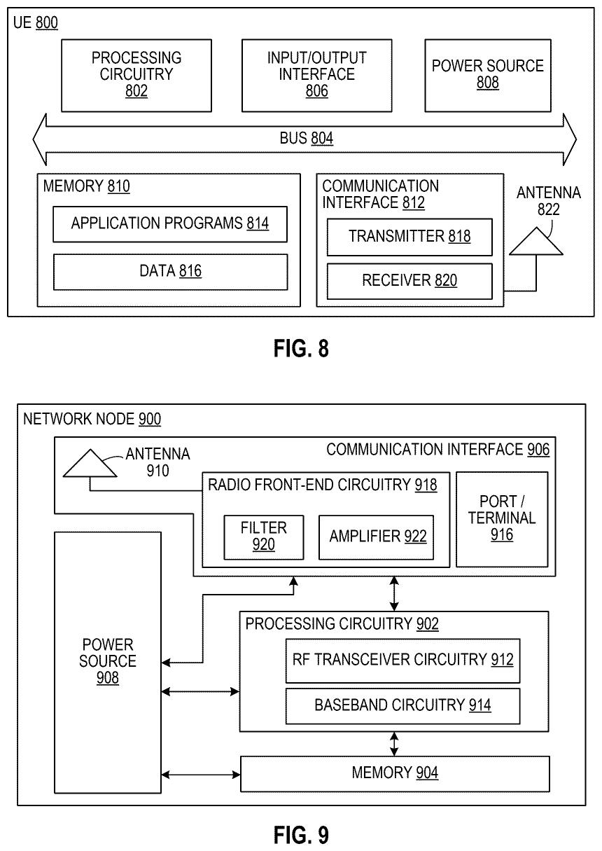

FIG. 8 shows a UE 800 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 800 includes processing circuitry 802 that is operatively coupled via a bus 804 to an input/output interface 806, a power source 808, a memory 810, a communication interface 812, and/or any other component, or any combination thereof. Certain UEs may utilize all or a subset of the components shown in FIG. 8. The level of integration between the components may vary from one UE to another UE. Further, certain UEs may contain multiple instances of a component, such as multiple processors, memories, transceivers, transmitters, receivers, etc.

The processing circuitry 802 is configured to process instructions and data and may be configured to implement any sequential state machine operative to execute instructions stored as machine-readable computer programs in the memory 810. The processing circuitry 802 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 802 may include multiple central processing units (CPUs).

In the example, the input/output interface 806 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 800. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 808 is structured as a battery or battery pack. Other types of power sources, such as an external power source (e.g., an electricity outlet), photovoltaic device, or power cell, may be used. The power source 808 may further include power circuitry for delivering power from the power source 808 itself, and/or an external power source, to the various parts of the UE 800 via input circuitry or an interface such as an electrical power cable. Delivering power may be, for example, for charging of the power source 808. Power circuitry may perform any formatting, converting, or other modification to the power from the power source 808 to make the power suitable for the respective components of the UE 800 to which power is supplied.

The memory 810 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 810 includes one or more application programs 814, such as an operating system, web browser application, a widget, gadget engine, or other application, and corresponding data 816. The memory 810 may store, for use by the UE 800, any of a variety of various operating systems or combinations of operating systems.

The memory 810 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 810 may allow the UE 800 to access instructions, application programs and the like, stored on transitory or non-transitory memory media, to off-load data, or to upload data. An article of manufacture, such as one utilizing a communication system may be tangibly embodied as or in the memory 810, which may be or comprise a device-readable storage medium.

The processing circuitry 802 may be configured to communicate with an access network or other network using the communication interface 812. The communication interface 812 may comprise one or more communication subsystems and may include or be communicatively coupled to an antenna 822. The communication interface 812 may include one or more transceivers used to communicate, such as by communicating with one or more remote transceivers of another device capable of wireless communication (e.g., another UE or a network node in an access network). Each transceiver may include a transmitter 818 and/or a receiver 820 appropriate to provide network communications (e.g., optical, electrical, frequency allocations, and so forth). Moreover, the transmitter 818 and receiver 820 may be coupled to one or more antennas (e.g., antenna 822) and may share circuit components, software or firmware, or alternatively be implemented separately.

In the illustrated embodiment, communication functions of the communication interface 812 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 812, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 800 shown in FIG. 8.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 9 shows a network node 900 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 900 includes a processing circuitry 902, a memory 904, a communication interface 906, and a power source 908. The network node 900 may be composed of multiple physically separate components (e.g., a NodeB component and a RNC component, or a BTS component and a BSC component, etc.), which may each have their own respective components. In certain scenarios in which the network node 900 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 900 may be configured to support multiple radio access technologies (RATs). In such embodiments, some components may be duplicated (e.g., separate memory 904 for different RATs) and some components may be reused (e.g., a same antenna 910 may be shared by different RATs). The network node 900 may also include multiple sets of the various illustrated components for different wireless technologies integrated into network node 900, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 900.

The processing circuitry 902 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 900 components, such as the memory 904, to provide network node 900 functionality.

In some embodiments, the processing circuitry 902 includes a system on a chip (SOC). In some embodiments, the processing circuitry 902 includes one or more of radio frequency (RF) transceiver circuitry 912 and baseband processing circuitry 914. In some embodiments, the radio frequency (RF) transceiver circuitry 912 and the baseband processing circuitry 914 may be on separate chips (or sets of chips), boards, or units, such as radio units and digital units. In alternative embodiments, part or all of RF transceiver circuitry 912 and baseband processing circuitry 914 may be on the same chip or set of chips, boards, or units.

The memory 904 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 902. The memory 904 may store any suitable instructions, data, or information, including a computer program, software, an application including one or more of logic, rules, code, tables, and/or other instructions capable of being executed by the processing circuitry 902 and utilized by the network node 900. The memory 904 may be used to store any calculations made by the processing circuitry 902 and/or any data received via the communication interface 906. In some embodiments, the processing circuitry 902 and memory 904 is integrated.

The communication interface 906 is used in wired or wireless communication of signaling and/or data between a network node, access network, and/or UE. As illustrated, the communication interface 906 comprises port(s)/terminal(s) 916 to send and receive data, for example to and from a network over a wired connection. The communication interface 906 also includes radio front-end circuitry 918 that may be coupled to, or in certain embodiments a part of, the antenna 910. Radio front-end circuitry 918 comprises filters 920 and amplifiers 922. The radio front-end circuitry 918 may be connected to an antenna 910 and processing circuitry 902. The radio front-end circuitry may be configured to condition signals communicated between antenna 910 and processing circuitry 902. The radio front-end circuitry 918 may receive digital data that is to be sent out to other network nodes or UEs via a wireless connection. The radio front-end circuitry 918 may convert the digital data into a radio signal having the appropriate channel and bandwidth parameters using a combination of filters 920 and/or amplifiers 922. The radio signal may then be transmitted via the antenna 910. Similarly, when receiving data, the antenna 910 may collect radio signals which are then converted into digital data by the radio front-end circuitry 918. The digital data may be passed to the processing circuitry 902. In other embodiments, the communication interface may comprise different components and/or different combinations of components.

In certain alternative embodiments, the network node 900 does not include separate radio front-end circuitry 918, instead, the processing circuitry 902 includes radio front-end circuitry and is connected to the antenna 910. Similarly, in some embodiments, all or some of the RF transceiver circuitry 912 is part of the communication interface 906. In still other embodiments, the communication interface 906 includes one or more ports or terminals 916, the radio front-end circuitry 918, and the RF transceiver circuitry 912, as part of a radio unit (not shown), and the communication interface 906 communicates with the baseband processing circuitry 914, which is part of a digital unit (not shown).

The antenna 910 may include one or more antennas, or antenna arrays, configured to send and/or receive wireless signals. The antenna 910 may be coupled to the radio front-end circuitry 918 and may be any type of antenna capable of transmitting and receiving data and/or signals wirelessly. In certain embodiments, the antenna 910 is separate from the network node 900 and connectable to the network node 900 through an interface or port.

The antenna 910, communication interface 906, and/or the processing circuitry 902 may be configured to perform any receiving operations and/or certain obtaining operations described herein as being performed by the network node. Any information, data and/or signals may be received from a UE, another network node and/or any other network equipment. Similarly, the antenna 910, the communication interface 906, and/or the processing circuitry 902 may be configured to perform any transmitting operations described herein as being performed by the network node. Any information, data and/or signals may be transmitted to a UE, another network node and/or any other network equipment.

The power source 908 provides power to the various components of network node 900 in a form suitable for the respective components (e.g., at a voltage and current level needed for each respective component). The power source 908 may further comprise, or be coupled to, power management circuitry to supply the components of the network node 900 with power for performing the functionality described herein. For example, the network node 900 may be connectable to an external power source (e.g., the power grid, an electricity outlet) via an input circuitry or interface such as an electrical cable, whereby the external power source supplies power to power circuitry of the power source 908. As a further example, the power source 908 may comprise a source of power in the form of a battery or battery pack which is connected to, or integrated in, power circuitry. The battery may provide backup power should the external power source fail.

Embodiments of the network node 900 may include additional components beyond those shown in FIG. 9 for providing certain aspects of the network node's functionality, including any of the functionality described herein and/or any functionality necessary to support the subject matter described herein. For example, the network node 900 may include user interface equipment to allow input of information into the network node 900 and to allow output of information from the network node 900. This may allow a user to perform diagnostic, maintenance, repair, and other administrative functions for the network node 900.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### REFERENCES

[1] 3GPP TS 38.331 v17.1.0
[2] 3GPP TS 38.133 v18.0.0
[3] 3GPP RP-213565

1. A method by a user equipment, UE, for performing an L1/L2 based inter-cell mobility, LTM, cell switch, the method comprising:
receiving an LTM configuration including an LTM candidate cell configuration for the LTM cell switch;
receiving an indication of an LTM candidate cell;
performing downlink, DL, pre-synchronization with the LTM candidate cell;
receiving an LTM cell switch command from a serving cell indicating that the UE needs to access and switch to the LTM candidate cell; and
transmitting, in response to the LTM cell switch command, an uplink, UL, signal to the LTM candidate cell.

2. The method of claim 1, wherein the indication is received in a radio resource control message.

3. The method of claim 1, wherein the indication is received in a medium access control, MAC, control element, CE.

4. The method of claim 1, wherein the indication is received in Layer 1 or Layer 2 signalling, or in a physical downlink control channel, PDCCH, order.

5. The method of claim 1, wherein the LTM configuration comprises LTM candidate cell configurations for a plurality of LTM candidate cells, wherein the indication indicates which of the plurality of LTM candidate cells the UE should perform DL synchronization with.

6. The method claim 1, wherein transmitting the UL signal comprises transmitting the UL signal in a configured UL channel resource(s) in time and frequency.

7. The method of claim 1, wherein the UE is configured with a plurality of LTM candidate cell configurations for a plurality of LTM candidate cells, the method further comprising:
selecting a subset of the LTM candidate cells for performing DL synchronization before receiving the LTM cell switch command, wherein the selection of the subset of the LTM candidate cells is based on one or more rules.

8. The method of claim 1, wherein the LTM cell switch command corresponds to a MAC Control Element (MAC CE), a Downlink Control Indication (DCI), a Layer 1, L1, signaling, a Layer 2, L2, signaling, and/or an L1/L2 signaling.

9-14. (canceled)

15. A method by a network node for causing a user equipment, UE, to perform an L1/L2 based inter-cell mobility, LTM, cell switch with an LTM candidate cell, the method comprising:
transmitting an LTM configuration including an LTM candidate cell configuration to cause the UE to perform downlink, DL, pre-synchronization with an LTM candidate cell;
transmitting an indication of an LTM candidate cell; and
transmitting an LTM cell switch command to the UE indicating that the UE needs to access and switch to the LTM candidate cell.

16. The method of claim 9, wherein the indication is transmitted in a radio resource control message.

17. The method of claim 9, wherein the indication is transmitted in a medium access control, MAC, control element, CE.

18-25. (canceled)

26. User equipment, UE, configured for an L1/L2 based inter-cell mobility, LTM, cell switch, the UE being configured to:
receive an LTM configuration including an LTM candidate cell configuration for the LTM cell switch;
receive an indication of an LTM candidate cell;
perform downlink, DL, pre-synchronization with the LTM candidate cell;
receive an LTM cell switch command from a serving cell indicating that the UE needs to access and switch to the LTM candidate cell; and
transmit, in response to the LTM cell switch command, an uplink, UL, signal to the LTM candidate cell.

27. The UE of claim 12, wherein the indication is received in a radio resource control message, in a medium access control (MAC) control element (CE), in Layer 1 or Layer 2 signalling, in a physical downlink control channel (PDCCH) order.

28. A network node configured to cause a user equipment, UE, to perform an L1/L2 based inter-cell mobility, LTM, cell switch with an LTM candidate cell, the network node being configured to:
transmit an LTM configuration including an LTM candidate cell configuration to cause the UE to perform downlink, DL, pre-synchronization with an LTM candidate cell;
transmit an indication of an LTM candidate cell; and
transmit an LTM cell switch command to the UE indicating that the UE needs to access and switch to the LTM candidate cell.

29. The network node of claim 28, wherein the indication is transmitted in a radio resource control message or in a medium access control (MAC) control element (CE).
